(19) United States
(12) Patent Application Publication
(10) Pub. No.: US 2020/0257608 A1
(43) Pub. Date: Aug. 13, 2020

(54) ANOMALY DETECTION IN MULTIPLE CORRELATED SENSORS

(71) Applicant: Siemens Aktiengesellschaft, Munich (DE)

(72) Inventor: Dmitriy Fradkin, Princeton, NJ (US)

(21) Appl. No.: 15/774,386

(22) PCT Filed: Nov. 19, 2015
(86) PCT No.: PCT/US2015/061506

§ 371 Date: May 8, 2018

(51) Int. Cl. G06F 11/34; G06F 11/30; G05B 23/02

(52) U.S. Cl. CPC G06F 11/3452; G06F 11/3409; G05B 23/0254; G05B 23/0221; G06F 11/3006

(57) ABSTRACT

Embodiments include methods, systems and computer program products for detecting an anomaly in data provided by each one of a plurality of correlated sensors. Aspects include receiving time series data sequences from each one of a plurality of correlated sensors, determining a numeric representation for each one of the time series data sequences, determining an anomaly score for each one of the time series data sequences using the determined numeric representation for each one of the time series data sequences, and determining a distribution of the determined anomaly scores under normal conditions.

### BACKGROUND

The present disclosure relates to the detection of anomalies within sensed or measured data, and more specifically, to methods, systems and computer program products for the detection of anomalies within sensed or measured data provided by multiple “strongly” correlated sensors which are sensors that are making the same type of measurement (e.g., temperature) and are in relatively close proximity to one another (e.g., within the rooms of a house).

An anomaly is commonly defined as at least one data point that differs in its actual sensed or measured value significantly enough from the sensed or measured values of the remaining data points in a group, pattern, string or sequence of data so as to cause the anomaly to be flagged as being at least possibly problematic. That is, for historical reasons or otherwise, the sensed or measured data suggests an expected “normal” value or range of normal values for the sensed data, and the anomaly is a data value that does not match or fit closely enough within that normal value or range of normal values of the data. Other common names for anomalies include outliers, deviations, abnormalities, surprises, intrusions, exceptions, etc. The group of data points being sensed and examined for anomalies oftentimes may be referred to as a time series, which is a sequence or pattern of data measured over a period of time in which each data point corresponds to a discrete point or sensed value in time (e.g., one data point sensed per second over a one hour period). Anomaly detection finds widespread usage in various and differing applications involving data detection, analysis and processing.

When an anomaly is sensed or detected, it often triggers some type of follow-on or subsequent procedure, for example one that identifies the cause of the anomaly and/or prevents the anomaly from causing harm to the system that contains or utilizes the data, such as a type of process control system, or a procedure that even corrects for problems to the system caused by the detected anomaly. Thus, in general, anomaly detection refers to detecting a pattern or patterns in a given dataset that do not conform to an established, expected or normal behavioral data pattern. Typically, it is desired to detect the anomaly as early or quickly as possible, before it causes harm to the underlying data processing system.

In general, the role of technology in our society is continuously increasing, and new uses and applications for existing technologies are discovered every day. One such area is in the use of sensors to monitor the environment and to monitor control equipment, for example, in industrial applications and in everyday public use. Examples may include environmental sensors located outdoors, temperature sensors located in various rooms of a house, and multiple types of sensors located, for example, in cars, trains, offices, factories, and computer networks.

Thus, one of the main goals of sensor monitoring schemes is the detection and prevention of malfunctions to control equipment by identifying anomalies as soon as possible in the measurement data provided by the sensors. Methods exist that can locate or determine anomalies in time series data—particularly with respect to statistical data packages.

However, what is needed is a method, system and computer program product that detects anomalies in the presence of multiple, relatively “strongly” correlated sensors, such as a plurality of sensors that are spatially located relatively close to one another and are making the same type of measurements; for example temperature sensors located in different rooms of the same house, located in different cars of a train, or located in different locations of a workplace such as an office or an industrial plant or facility. With such “strongly” correlated sensors, an accurate assumption is that the sensed or measured data values of the sensors should behave similarly (e.g., temperature sensors in the rooms of a house should provide an indication of temperature in each room that is approximately equal to one another), even though the sensor data is dynamic (e.g., the house is heated or cooled fairly uniformly).

### SUMMARY

In accordance with an embodiment, a method for detecting an anomaly in data provided by each one of a plurality of correlated sensors is provided. The method includes receiving from each one of the plurality of correlated sensors a corresponding time series data sequence, each data sequence representing a plurality of data values sensed by a corresponding one of the plurality of correlated sensors at a sampling frequency, each of the data values of each data sequence being sensed at a particular point in time in the time series data sequence. The method also includes determining a numeric representation for each one of the time series data sequences, determining an anomaly score for each one of the time series data sequences using the determined numeric representation for each one of the time series data sequences, and determining a distribution of the determined anomaly scores under normal conditions.

In accordance with another embodiment, a system that detects an anomaly in data provided by each one of a plurality of correlated sensors includes a processor in communication with one or more types of memory. The processor is configured to receive from each one of the plurality of correlated sensors a corresponding time series data sequence, each data sequence representing a plurality of data values sensed by a corresponding one of the plurality of correlated sensors at a sampling frequency, each of the data values of each data sequence being sensed at a particular point in time in the time series data sequence. The processor is also configured to determine a numeric representation for each one of the time series data sequences, to determine an anomaly score for each one of the time series data sequences using the determined numeric representation for each one of the time series data sequences, and to determine a distribution of the determined anomaly scores under normal conditions.

In accordance with yet another embodiment, a computer program product for detecting an anomaly in data provided by each one of a plurality of correlated sensors is described. The computer program product includes computer readable storage medium having computer executable instructions embodied thereon. The computer readable storage medium includes instructions to receive from each one of the plurality of correlated sensors a corresponding time series data sequence, each data sequence representing a plurality of data values sensed by a corresponding one of the plurality of correlated sensors at a sampling frequency, each of the data values of each data sequence being sensed at a particular point in time in the time series data sequence. The computer readable storage medium also includes instructions to determine a numeric representation for each one of the time series data sequences, to determine an anomaly score for each one of the time series data sequences using the determined numeric representation for each one of the time series data sequences, and to determine a distribution of the determined anomaly scores under normal conditions.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a block diagram illustrating one example of a processing system for practice of the teachings herein;

FIG. 2 is a block diagram of a house having multiple or a plurality of temperature sensors located in various rooms of the house and having a data processing system that, together with the multiple sensors, comprise an anomaly detection system in accordance with an exemplary embodiment; and

FIG. 3 is a flow diagram of a method for detecting an anomaly in data provided by the plurality of correlated temperature sensors in accordance with an exemplary embodiment.

### DETAILED DESCRIPTION

In accordance with exemplary embodiments of the disclosure, methods, systems and computer program products for anomaly detection are provided. In exemplary embodiments, the anomaly detection methods, systems and computer program products are each configured to receive sensor data from each one of a plurality of sensors that are monitoring or sensing a parameter of an area, such as for example and without limitation the temperature of each room of a house. Due to the fact that in various embodiments the sensors are all similar in that they each measure the same parameter (e.g., temperature), and they are located within an area (e.g., a house) in which the sensors are by nature in close proximity to one another, the sensors and, thus, the sensor behavior (i.e., the output values) can be said to be “strongly” correlated. This is true even if the sensor data is dynamic—that is, the data values from the sensor are changing or varying over time (e.g., the temperature sensors within the house measure or sense different temperature values over a period of time such as an hour, a day, week, month, year, etc.).

In exemplary embodiments, the sensed, measured or detected sensor data may then be processed to determine the existence of an anomaly or anomalies within the pattern or time sequence of sensor data. If one or more anomalies are determined, then corrective action may be taken to determine the cause of the anomaly and/or to prevent damage the underlying process control system that such an anomaly detection method, system and/or computer program product in accordance with embodiments of the present invention may resides in.

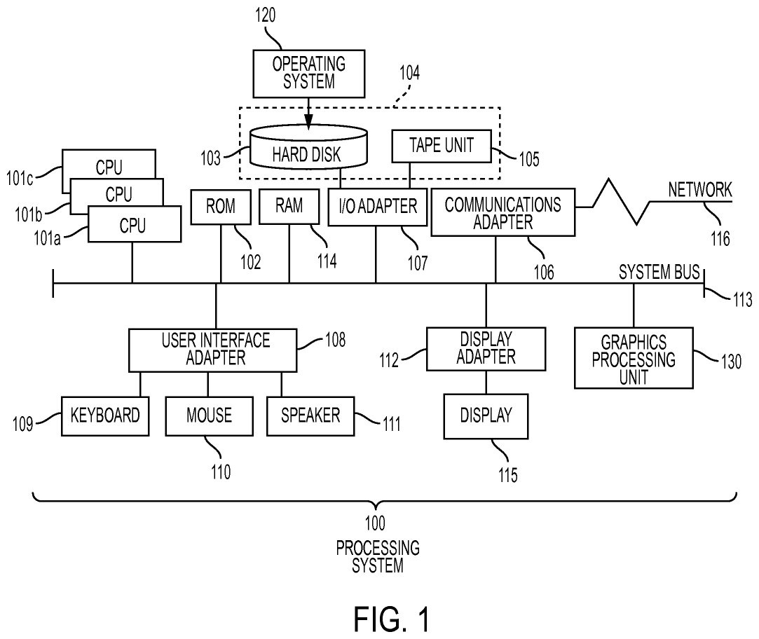

Referring to FIG. 1, there is shown an embodiment of a processing system 100 for implementing the teachings herein. In this embodiment, the system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 1 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Operating system 120 for execution on the processing system 100 may be stored in mass storage 104. A network adapter 106 interconnects bus 113 with an outside network 116 enabling data processing system 100 to communicate with other such systems. A screen (e.g., a display monitor) 115 is connected to system bus 113 by display adapter 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

In exemplary embodiments, the processing system 100 includes a graphics processing unit 130. Graphics processing unit 130 is a specialized electronic circuit designed to manipulate and alter memory to accelerate the creation of images in a frame buffer intended for output to a display. In general, graphics processing unit 130 is very efficient at manipulating computer graphics and image processing, and has a highly parallel structure that makes it more effective than general-purpose CPUs for algorithms where processing of large blocks of data is done in parallel.

Thus, as configured in FIG. 1, the system 100 includes processing capability in the form of processors 101, storage capability including system memory 114 and mass storage 104, input means such as keyboard 109 and mouse 110, and output capability including speaker 111 and display 115. The system 100 may be, but is not limited to, a mainframe computer, a desktop computer, a laptop computer, a mobile phone, a smartphone, a wireless tablet or the like.

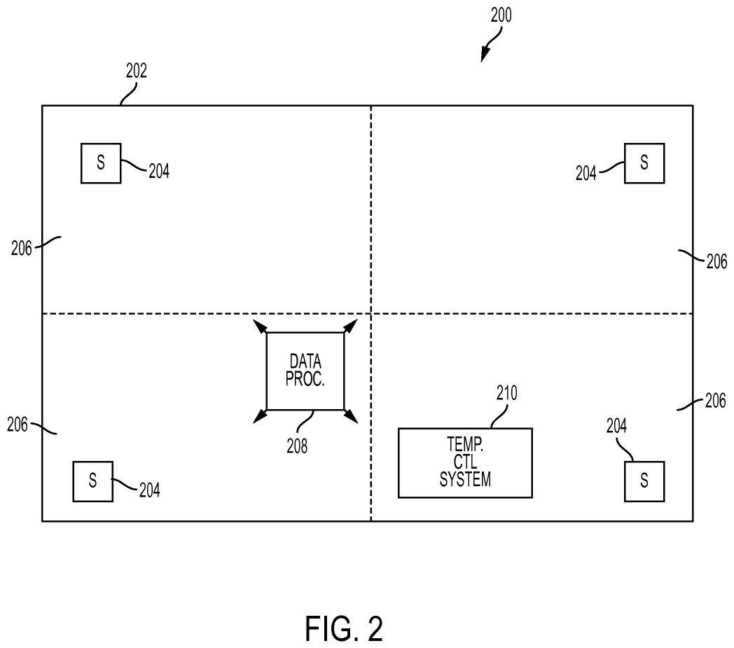

Referring to FIG. 2, in an exemplary embodiment of the teachings herein, an anomaly detection system 200 is embodied in a house 202 and includes a plurality of temperature sensors “S” 204, one or more of the sensors 204 being located in each of the various rooms 206 of the house 202. As illustrated in FIG. 2, there are four temperature sensors 204 shown, one for each room in the house 202. However, it is to be understood that in other embodiments the anomaly detection system 200 may reside in something other than a house (e.g., an automobile, a train, an office, a plant, an industrial facility, etc.), and may utilize more or less than four sensors, including more than one per room.

In addition, in other embodiments the anomaly detection system 200 may utilize a type of data other than temperature data, for example, velocity, weight, pressure, or various types of financial information, etc. The various types of financial information or data may be used with an anomaly detection system of the teachings of the present invention, for example, to detect a fraudulent transaction by detecting an abnormal type of financial transaction, such as a relatively large monetary withdrawal from a financial institution like a bank in an account that typically has not had such a large withdrawal in the past, or a withdrawal from an account at a financial institution like a remote ATM in a location that is relatively far from the account holder's location. Such a relatively large geographical disparity between the account holder's location and the location of the ATM withdrawal may often signal an anomaly in that the account holder's information (e.g., the account number and password) has been compromised by another and corrective action is needed immediately to prevent further unauthorized financial transactions.

The broadest scope of the present invention contemplates a wide range of data processing systems or process control systems that have a need for successfully detecting anomalies in the data utilized within such systems. The temperature detection method, system and computer program product described and illustrated herein should be understood to comprise merely one exemplary type of embodiment of the broadest scope of the teachings of the present invention.

As illustrated in FIG. 2, the anomaly detection system 200 also includes a data processing system 208, which may be a data processing system similar to the processing system 100 shown and described hereinabove with reference to FIG. 1. The data processing system 208, which may be physically located within the house 202 in an exemplary embodiment, is configured to receive sensor data from each of the plurality (i.e., four) of correlated temperature sensors 204. The data processing system 208 may communicate wirelessly with each temperature sensor 204 or in a wired manner. Each temperature sensor 204 may provide its temperature data to the data processing system 208 in a time series such that each sensor 204 may provide its data at discrete points in time (e.g., once per second, once per minute, once per hour, etc.). This may be accomplished, for example, by having each sensor 204 provide its temperature data continuously and having the data processing system then read each sensor's data periodically at the desired time intervals, e.g., once per second, once per minute, once per hour, etc.

The data processing system 208 may be utilized in conjunction with a temperature control system 210 for the house 202—for example a heating/cooling system 210 such as a commonly known system powered by gas, electricity, oil, etc. That is, the heating/cooling system 210 is a process control system that is responsive to the data processing system 208 to control the temperature in each room 206 of the house 202 to a desired value. Typically such a temperature control system is a closed loop system in which a user sets a desired temperature for each room or for all of the rooms in a house. The system then uses the sensed values for the actual temperature in each room and compares those values to the desired or user-specified values and then provides the necessary amount of heating or cooling air to each room such that the actual temperature in each room equals the desired temperature.

As such, in exemplary embodiments of the present invention, the anomaly detection system 200 is used to provide for proper and safe operation of the heating/cooling (process control) system 210 for the house 202 by detecting any anomalies that may occur in the sensed or measured temperature readings provided by the temperature sensors 204. The system 200 then prevents any such anomalies from causing the heating/cooling system 210 to malfunction in a way that could have deleterious effects on the system 210 and/or the occupants of the house 202.

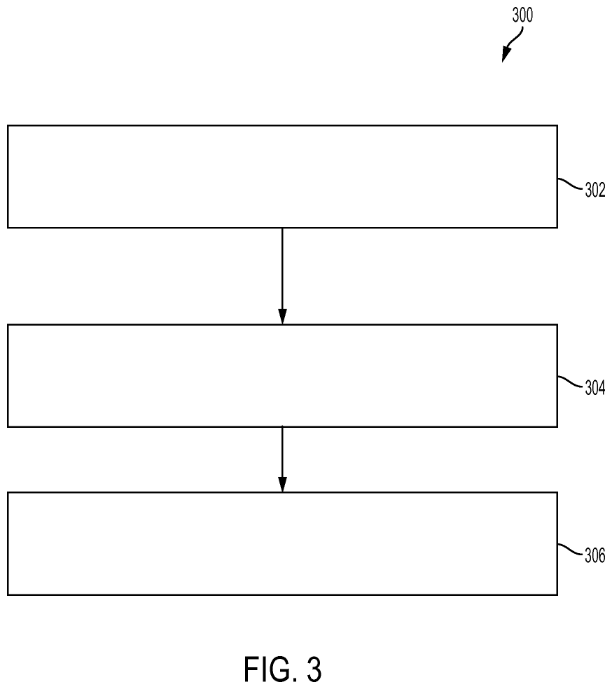

Referring to FIG. 3, there illustrated is a flow diagram of a method 300 for anomaly detection in accordance with an exemplary embodiment. As shown at block 302, the method 300 includes a step in which a numeric representation is determined (e.g., computed) for each time series of temperature data (e.g., computed by the data processing system 208). Thus, from the exemplary embodiment of FIG. 2, a numeric representation is computed for each of the time series of data provided by each of the four corresponding temperature sensors 204. Multiple approaches for this block 302 are possible.

One approach is if the sampling frequency is the same for all of the temperature sensors 204, then the vectors of values will be of the same length, and thus, the determination of the numeric representation is straightforward. This common vector length allows for the data for each time series to be compared directly with one another.

Another approach is possible if the sampling frequency is not the same for all of the temperature sensors 204. In this situation, a vector of statistics can be computed or determined for each time series—for example, a maximum, minimum, mean, standard deviation, higher order moments, etc. This allows for a direct comparison of the data for each time series.

Next, as shown at block 304, an anomaly score is determined (e.g., computed by the data processing system 208) in a step for each one of time series data sequences from the corresponding temperature sensors 204 using the numeric representation computed for each time series of temperature data in the block 302 above. For example, an average distance (e.g., Euclidean, Manhattan, or weighted) in terms of sensed data from each temperature sensor 204 to the other temperature sensors 204 may be computed or determined using the determined numeric data representation. The sensor 204 with the higher score may be considered to be relatively more isolated (data-wise) from the other sensors 204. Alternatively a minimum distance from each sensor 204 to the other sensors 204 may be computed or determined using the determined numeric data representation, or a sum of the differences between the sensors 204 may be computed or determined using the determined numeric data representation.

Next, as shown at block 306, the distribution of anomaly scores under normal conditions is determined in a step (e.g., computed by the data processing system 208). By “normal” conditions it is meant that there are no known problems with the temperature measurements from the sensors 204. As such, an alert may be triggered wherein only anomaly scores exceeding one or more thresholds exist, or one or more anomaly scores being sufficiently different from the other anomaly scores exist. In an exemplary embodiment, historical data may be utilized in this step.

One exemplary method to determine the distribution of anomaly scores is to determine the mean and standard deviation of the anomaly scores and apply statistical tests to determine whether or not the anomaly scores are within range or are out of range such that an alert may be triggered. Another exemplary method is to establish a ranking of the sensors based on anomaly scores and report violations of the ranking (i.e., a sensor 204 having a value that has become a relatively greater outlier or anomaly than before). Still another exemplary method is that the thresholds for anomaly score deviation may be set manually based on domain experience.

The exemplary embodiments of the anomaly detection method of the present invention, such as those described hereinabove and illustrated in the flow diagram of FIG. 3, can be applied either in an online mode or in a batch mode. In an online mode, the anomaly detection method may be applied to the data from the temperature sensors 204 in real time. As such, the method will determine whether or not to trigger an alert at each data point in the time sequence of data points. In contrast, in batch mode, the anomaly detection method may process the data gathered over a relatively large period of time (e.g., one hour, one day, etc.) and identify and rank (e.g., by anomaly score) possible anomalies for review at some later point in time by a human or a computer.

The relatively large period of time (e.g., one hour or one day) in which data is gathered in batch mode may be referred to as a “sliding window,” which may be a user-specified parameter. Relatively small windows are generally more sensitive to small drifts in the sensor data. This can allow for detection of an anomaly sooner. However, such relatively small windows can lead to false alerts. On the other hand, using relatively large windows may make the results more stable, but can miss smaller anomalies. The “optimal” size of the sliding window may be determined, for example, based on domain expertise, historic data, or some other methodology.

The importance of features of a vector representing a sliding window may vary. This is true both when using original measurement data values as vectors or when using derived values (e.g., a mean value). Therefore, it may be useful to apply weighting to these features when computing distances between windows. These weights can once again be adjusted manually, or can be learned automatically if sufficient historic data is available.

The appropriate measures for evaluating parameter choices (e.g., weights, thresholds, etc.), as well as the overall performance of the method, are sensitivity-specificity curves. Sensitivity is the fraction of all positives (i.e., anomalies) that are correctly detected (i.e., the number of true positives divided by all anomalies), while specificity is the fraction of all normals (i.e., non-anomalies) that are correctly identified as such (i.e., the number of true negatives (non-anomalies) divided by the number of all normal cases).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method for detecting an anomaly in data provided by each one of a plurality of correlated sensors, the method comprising:
receiving from each one of the plurality of correlated sensors a corresponding time series data sequence, each data sequence representing a plurality of data values sensed by a corresponding one of the plurality of correlated sensors at a sampling frequency, each of the data values of each data sequence being sensed at a particular point in time in the time series data sequence, wherein the correlated sensors have a correlation related to a common measured parameter or a relative proximity to one another;
determining a numeric representation for each one of the time series data sequences, wherein on a condition that the sampling frequency is not the same for each one of the plurality of correlated sensors, a vector of statistics for each one of the plurality of data values is computed for each time series data sequence;
determining an anomaly score for each one of the time series data sequences using the determined numeric representation for each one of the time series data sequences; and
determining a distribution of the determined anomaly scores under normal conditions.

2. (canceled)

3. (canceled)

4. The method of claim 1, wherein the vector of statistics includes one of a maximum value, a minimum value, a mean value, a standard deviation value, or higher order moments.

5. The method of claim 1, wherein the step of determining an anomaly score using the determined numeric representation for each one of the time series data sequences comprises:
determining an average distance in terms of sensed data from each sensor to each one of the plurality of sensors using the determined numeric representation for each one of the time series data sequences;
determining a minimum distance between each one of the plurality of sensors using the determined numeric representation for each one of the time series data sequences; or
determining a sum of the differences between the plurality of sensors using the determined numeric representation for each one of the time series data sequences.

6. The method of claim 1, wherein the step of determining a distribution of the determined anomaly scores under normal conditions comprises:
determining a mean and a standard deviation of the determined anomaly scores and applying and applying statistical tests to determine whether or not the determined anomaly scores are within range or are out of range; or
establishing a ranking of the sensors based on the determined anomaly scores and reporting a violation of the established ranking.

7. The method of claim 1, wherein the plurality of correlated sensors comprise temperature sensors located within a defined area.

8. A system for detecting an anomaly in data provided by each one of a plurality of correlated sensors includes a processor in communication with one or more types of memory, the processor being configured to:
receive from each one of the plurality of correlated sensors a corresponding time series data sequence, each data sequence representing a plurality of data values sensed by a corresponding one of the plurality of correlated sensors at a sampling frequency, each of the data values of each data sequence being sensed at a particular point in time in the time series data sequence, wherein the correlated sensors have a correlation related to a common measured parameter or a relative proximity to one another;
determine a numeric representation for each one of the time series data sequences, wherein on a condition that the sampling frequency is not the same for each one of the plurality of correlated sensors, a vector of statistics for each one of the plurality of data values is computed for each time series data sequence;
determine an anomaly score for each one of the time series data sequences using the determined numeric representation for each one of the time series data sequences; and
determine a distribution of the determined anomaly scores under normal conditions.

9. (canceled)

10. (canceled)

11. The system of claim 8, wherein the vector of statistics is one of a maximum value, a minimum value, a mean value, a standard deviation value, or higher order moments.

12. The system of claim 8, wherein when the processor determines an anomaly score using the determined numeric representation for each one of the time series data sequences, the processor further:
determines an average distance in terms of sensed data from each sensor to each one of the plurality of sensors using the determined numeric representation for each one of the time series data sequences;
determines a minimum distance between each one of the plurality of sensors using the determined numeric representation for each one of the time series data sequences; or
determines a sum of the differences between the plurality of sensors using the determined numeric representation for each one of the time series data sequences.

13. The system of claim 8, wherein when the processor determines a distribution of the determined anomaly scores under normal conditions, the processor further:
determines a mean and a standard deviation of the determined anomaly scores and applies statistical tests to determine whether or not the determined anomaly scores are within range or are out of range; or
establishes a ranking of the sensors based on the determined anomaly scores and reports a violation of the established ranking.

14. The system of claim 8, wherein the plurality of correlated sensors comprise temperature sensors located within a defined area.

15. A computer program product for detecting an anomaly in data provided by each one of a plurality of correlated sensors comprises a computer readable storage medium having computer executable instructions embodied thereon, the computer readable storage medium comprises instructions to:
receive from each one of the plurality of correlated sensors a corresponding time series data sequence, each data sequence representing a plurality of data values sensed by a corresponding one of the plurality of correlated sensors at a sampling frequency, each of the data values of each data sequence being sensed at a particular point in time in the time series data sequence, wherein the correlated sensors have a correlation related to a common measured parameter or a relative proximity to one another;
determine a numeric representation for each one of the time series data sequences, wherein on a condition that the sampling frequency is not the same for each one of the plurality of correlated sensors, a vector of statistics for each one of the plurality of data values is computed for each time series data sequence;
determine an anomaly score for each one of the time series data sequences using the determined numeric representation for each one of the time series data sequences; and
determine a distribution of the determined anomaly scores under normal conditions.

16. (canceled)

17. (canceled)

18. The computer program product of claim 15, wherein the vector of statistics includes one of a maximum value, a minimum value, a mean value, a standard deviation value, or higher order moments.

19. The computer program product of claim 15, wherein when an anomaly score is determined using the determined numeric representation for each one of the time series data sequences, the computer readable storage medium further comprises instructions to:
determine an average distance in terms of sensed data from each sensor to each one of the plurality of sensors using the determined numeric representation for each one of the time series data sequences;
determine a minimum distance between each one of the plurality of sensors using the determined numeric representation for each one of the time series data sequences; or
determine a sum of the differences between the plurality of sensors using the determined numeric representation for each one of the time series data sequences.

20. The computer program product of claim 15, wherein when a distribution of the determined anomaly scores is determined under normal conditions, the computer readable storage medium further comprises instructions to:
determine a mean and a standard deviation of the determined anomaly scores and apply statistical tests to determine whether the determined anomaly scores are within range or out of range; or
establish a ranking of the sensors based on the determined anomaly scores and report a violation of the established ranking.

21. The method of claim 6, further comprising:
setting thresholds for any deviations of the determined anomaly scores, wherein the deviation may be set manually based on domain experience.

22. The system of claim 13, wherein the processor further:
sets thresholds for any deviations of the determined anomaly scores, wherein the deviation may be set manually based on domain experience.

23. The computer program product of claim 15, wherein the computer readable storage medium further comprises instructions to:
set thresholds for any deviations of the determined anomaly scores, wherein the deviation may be set manually based on domain experience.
